(19) United States
(12) Patent Application Publication
(10) Pub. No.: US 2018/0270014 A1
(43) Pub. Date: Sep. 20, 2018

(54) INFORMATION PROCESSING APPARATUS

(71) Applicant: Kabushiki Kaisha Toshiba, Minato-ku (JP)

(72) Inventor: Hirofumi MURATANI, Kawasaki (JP)

(73) Assignee: Kabushiki Kaisha Toshiba, Minato-ku (JP)

(21) Appl. No.: 15/674,619

(22) Filed: Aug. 11, 2017

(30) Foreign Application Priority Data
Mar. 17, 2017 (JP) 2017 -053466

(51) Int. Cl. H04L 1/00; H04L 9/32

(52) U.S. Cl. CPC H04L 1/0041; H04L 9/3278

(57) ABSTRACT

According to an embodiment, an information processing apparatus comprise a processor, a transmitter, and a receiver. The processor obtains a first PUF output. The transmitter transmits a transmitting data based on the first PUF output to an external apparatus. The receiver receives an error corrected data from the external apparatus. The error corrected data is obtained by an error correction to the first PUF output. And the processor is further configured to calculate information based on the error corrected data.

### CROSS-REFERENCE TO RELATED APPLICATIONS

This application is based upon and claims the benefit of priority from Japanese Patent Application No. 2017-053466, filed on Mar. 17, 2017; the entire contents of which are incorporated herein by reference.

### FIELD

Embodiments described herein relate generally to an information processing apparatus.

### BACKGROUND

Generally, devices have some physical properties values of which cannot be controlled enough during their production and each device has different value respectively. PUF (physically unclonable function) is a function to generate different information for each device by using the differences of the physical properties of the devices. Desirable physical properties for PUF meet following requirements. The requirements are (i) values output from PUFs are different depending on devices; (ii) it is difficult to counterfeit a device to make another device outputting the same value; and (iii) PUF of the same device output the same value every time, that is the PUF has reproducibility. Using these properties, a unique ID for a device can be generated, and the ID can be used to identify the device. In addition, these properties can be used in high safety key management. According to the key management, the key used in cryptographic processing in the device is derived from the output of the PUF at the timing when the key is necessary, and the key is deleted from a memory in the device when the key is not necessary. In this way, it can be prevented an attacker from analyzing the memory in the device to steal the key illegally.

Although the output of the PUF has reproducibility, noises may occur because the PUF uses slight differences of the physical property. Noises may be caused because of thermal noise, change of physical properties due to a temperature, aged deterioration or interference due to operation of a circuit other than PUF. When PUF is applied to device identification, a noise makes identification of devices difficult because a noise disturbs generation of a correct ID. When PUF is applied to key management, a noise affects key generation and the generated key may be different from the keys generated before, so a correct cryptographic processing is difficult. Therefore error correction is often applied to an output of PUF to deal with a noise.

### BRIEF DESCRIPTION OF THE DRAWINGS

FIG. 1 is a diagram exemplifying a connection between a key generation apparatus and the other apparatuses;

FIG. 2 is a diagram exemplifying a functional configuration of the key generation apparatus in the key initialization phase;

FIG. 3 is a diagram exemplifying a functional configuration of the key generation apparatus in the key regeneration phase;

FIG. 4 is a diagram exemplifying a functional configuration of an ID generation apparatus in an ID initialization phase;

FIG. 5 is a diagram exemplifying a functional configuration of the ID generation apparatus in an ID regeneration phase;

FIG. 6 is a diagram exemplifying hardware configuration of the key generation apparatus;

FIG. 7 is a diagram exemplifying hardware configuration of a calculating apparatus;

FIG. 8 is a diagram exemplifying hardware configuration of a calculating apparatus;

FIG. 9 is a diagram exemplifying hardware configuration of a calculating apparatus; and

FIG. 10 is a diagram exemplifying hardware configuration of a calculating apparatus.

### DETAILED DESCRIPTION

According to an embodiment, an information processing apparatus comprise a processor, a transmitter, and a receiver. The processor obtains a first PUF output. The transmitter transmits a transmitting data based on the first PUF output to an external apparatus. The receiver receives an error corrected data from the external apparatus. The error corrected data is obtained by an error correction to the first PUF output. And the processor is further configured to calculate information based on the error corrected data.

### First Embodiment

A key generation apparatus according to embodiments will be described in detail below with reference to the accompanying drawings. The key generation apparatus generates keys using output of PUF. The key generation apparatus has two phases, namely a key initialization phase and a key regeneration phase.

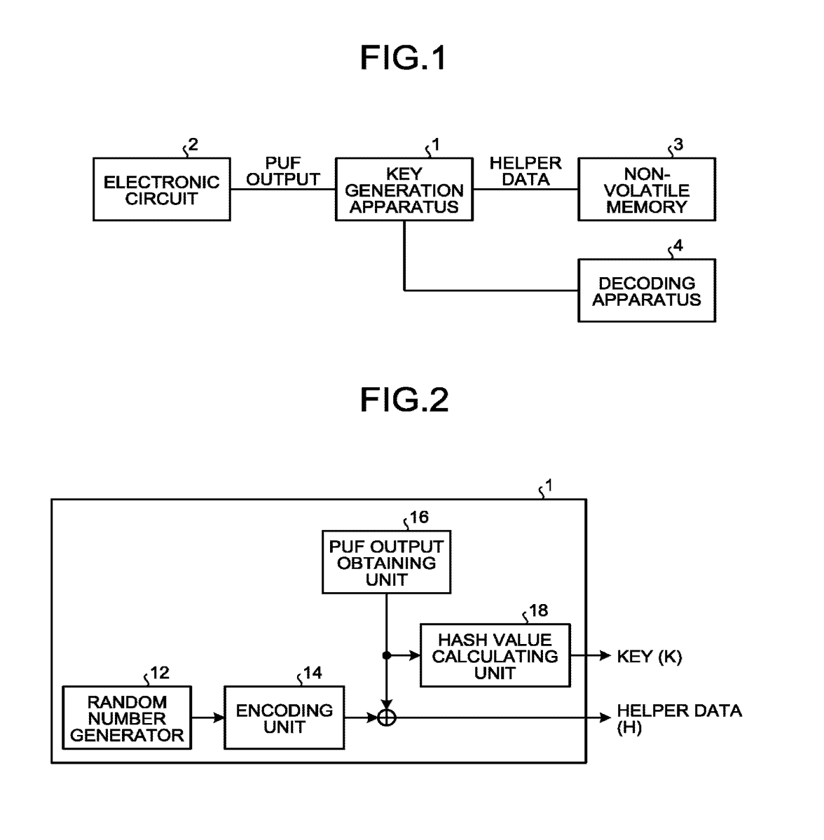

FIG. 1 is a diagram exemplifying a connection between a key generation apparatus and the other apparatuses. A key generation apparatus 1 connects an electronic circuit 2, non-volatile memory 3, and a decoding apparatus 4. PUF used in the key generation apparatus according to this embodiment is SRAM-PUF, for example. SRAM-PUF comprises a plurality of SRAM memory cells. The electronic circuit 2 according to this embodiment is the plurality of SRAM memory cells. Each of the memory cells of SRAM stabilize at a state of 1 or 0 after a power is supplied. The value is read and output as PUF output.

In the key initialization phase, the key generation apparatus 1 obtains PUF output from the electronic circuit 2, generates a key and a helper data, and stores the helper data to the non-volatile memory 3. In the key regeneration phase, the key generation apparatus 1 obtains the PUF output from the electronic circuit 2, obtains the helper data from the non-volatile memory 3, and regenerates the key. Even if the helper data is leaked, the security is not breached. The key can be regenerated using the helper data and the PUF output, therefore the key is not necessary to store, and the security can be maintained.

Also, in the key regeneration phase, the key generation apparatus 1 causes the decoding apparatus 4 to perform decoding process which is necessary to regenerate the key. The key generation apparatus 1 and the decoding apparatus 4 may be installed in the same housing as a one apparatus, or these apparatuses may be two apparatuses connected by a wired or wireless network. If the key generation apparatus 1 is an edge device of the IoT, the decoding apparatus 4 may be a gateway, or a cloud sever. For example, the decoding apparatus 4 may connects a plurality of the key generation apparatus 1, and the plurality of the key generation apparatus 1 may leave the decoding process to the decoding apparatus 4.

The key generation apparatus 1 according to this embodiment leave the decoding process to the decoding apparatus 4. Therefore, a decoding processing unit of which implementation cost is high is not necessary to install in the key generation apparatus 1.

FIG. 2 is a diagram exemplifying a functional configuration of the key generation apparatus 1 in the key initialization phase. Preferably, a random number generator 12 is a true random number generation circuit. However, if an entropy source which has sufficient entropy is ensured in the device, the random number generator 12 can be implemented by a pseudo random number generation circuit which obtains a random seed from the entropy source.

An encoding unit 14 encodes a random number sequence as an information bit sequence for an error correction, and generates a cord word (ENC(R)). PUF output obtaining unit 16 obtains PUF output (I). The helper data (H) is data which is obtained by superimposing the PUF output on the cord word by an exclusive OR operation for each bits. The helper data (H) is expressed by:

H=I⊕ENC(R) (1)

The helper data (H) is stored in the non-volatile memory 3. The helper data (H) is used in the key regeneration phase. PUF output (I) is input to a hash value calculating unit 18. The hash value calculating unit 18 outputs a key (K) which is obtained by calculating a hash value of the PUF output (I). Even if the helper data (H) is output to an outside of the key generation apparatus 1, the security is not breached. On the other hand, if the key (K) is output to an outside of the key generation apparatus 1, and the key (K) is leaked to an outsider, the security is breached.

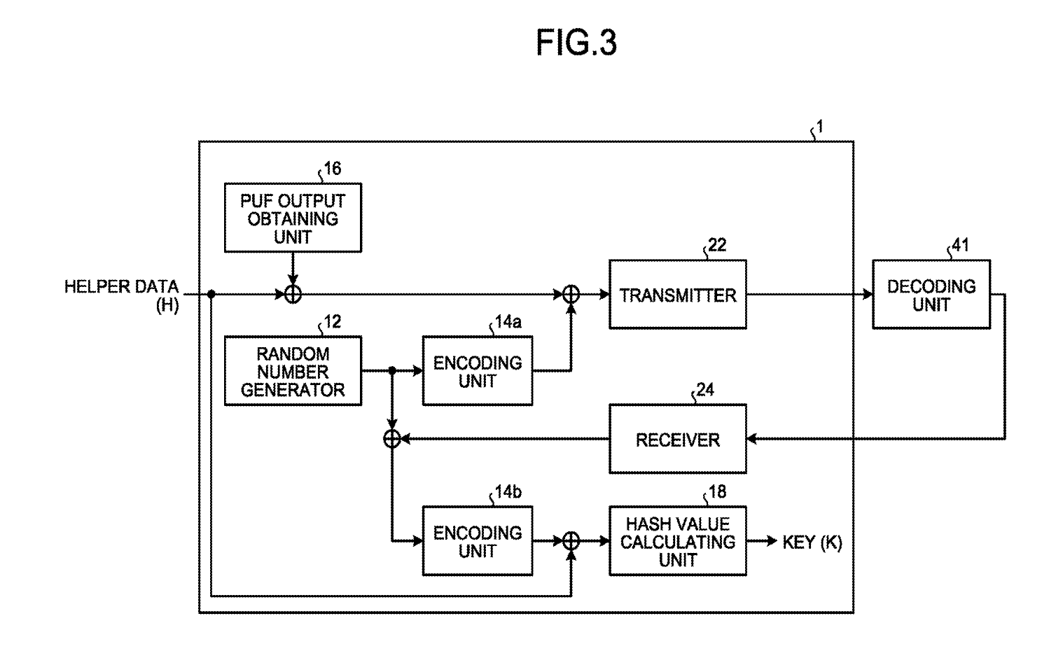

FIG. 3 is a diagram exemplifying a functional configuration of the key generation apparatus 1 in the key regeneration phase. An encoding unit 14a/14b, a PUF output obtaining unit 16 and a hash value calculating unit 18 in the key regeneration phase can use the same circuit as the encoding unit 14, PUF output obtaining unit 16 and the hash value calculating unit in the key initialing phase. A random number generator 12 in the key regeneration phase can use a different circuit from the random number generator 12 in the key initialization phase. The random number generator 12 in the key regeneration phase can use the same circuit as the random number generator 12 in the key initialization phase, provided that a random number sequence R generated in the key initialization phase shall not be correlated with a random number sequence R′ generated in the key regeneration phase.

The encoding units 14a and 14b in the key regeneration phase operate the same error correction coding as the encoding unit 14 in the key initialization phase. The error correction code used in the encoding unit 14/14a/14b is a linear code such as a binary BCH code.

According to this embodiment, the encoding unit 14, 14a and 14b use a binary BCH code which has high error correction capability as the error correction code. For example, if a bit error rate of the PUF output is 5%, the encoding unit 14, 14a and 14b use a primitive BCH code having a code length of 127 bits, an information bit length of 71 bits, parity bit length of 56 bits, and a correction capability of 9 (up to 9 bits error can be corrected). The correction capability (9/127) is 1.4 times as much as the bit error rate (5%) to expect a sufficient error correction capability. Therefore the possibility of failing to generate a key because of a noise of a PUF output is quite small.

If the key generation was failed, after that, a communication or decoding of data using the key cannot be done normally, so the failing of the key generation can be detected. In this case, the key generation apparatus 1 restart the key regeneration phase from the beginning. If average entropy of the PUF output per bit is small (for example 0.21), the PUF shall output 1270 bits, which is 10 times of 127 bits, to generate 256 bits key of AES encryption, which is a typical common key cryptosystem. If a SRAM-PUF is used, 1270 bits of memory cells should be ensured for PUF.

1270×0.21=266.7>256

In the key regeneration phase, at first, the helper data (H) stored in the non-volatile memory 3 is read. Then the PUF output (I′) obtained by the PUF output obtaining unit 16 is superimposed on the helper data (H). A noise may occur on the PUF output. Therefore, the PUF output (I) obtained by the PUF output obtaining unit 16 in the key initialization phase may be different from the PUF output (I′) obtained by the PUF output obtaining unit 16 in the key regeneration phase.

Next, the random number generator 12 generates a random number sequence (R′), and the encoding unit 14a encodes the random number sequence by the error correction codes to obtain a codeword (ENC(R′)). Then, the codeword (—ENC(R′)) is superimposed on the superimposed data of the helper data and the PUF output. The result of the superimposing is expressed by:

H⊕I′⊕ENC(R′)=I⊕I′⊕ENC(R)⊕ENC(R′) (2)

In the key regeneration phase according to this embodiment, the random number generator 12 generates a 710-bit random number sequence R′. Then, the random number sequence R′ is divided into ten random number sequences of 71 bits, and the encoding unit 14a performs encoding of BCH code to the 71-bit random number sequences to generate 10 codewords of 127 bits. The 1270-bit codeword (ENC(R′)) thus obtained is superimposed on the superimposed data of the helper data and the PUF output.

A transmitter 22 transmits the superimposed result to a decoding unit 41 of the decoding apparatus 4 to leave the decoding process. The decoding unit 41 decodes the error correction codes. In the decoding process, a differences between the PUF output (I) of the key initialization phase and the PUF output (I′) of the key regeneration phase can be considered as a noise on the codeword. If the error correction code is a linear code and a weight of the difference between the PUF output (I) of the key initialization phase and the PUF output (I′) of the key regeneration phase is within an error correction capability of the error correction code, the decoding unit 41 succeeds the error correction. When the error correction of the linear code is succeeded, the formula (3) is established.

DEC(H⊕I′(ENC(R′))=DEC(I⊕I′⊕ENC(R)⊕ENC(R′))=R⊕R′ (3)

The decoding unit 41 in this embodiment receives 1270-bit data from the key generation apparatus 1, divides the data into 10 data of 127 bits, and decodes each data of BCH code. Then the decoding unit 41 returns error corrected data of 710 bits, which consists of obtained 10 decoded data of 71 bits, to the key generation apparatus 1.

A receiver 24 of the key generation apparatus 1 receives the decoded data from the decoding unit 41 of the decoding apparatus 4. The key generation apparatus 1 superimposes the decoded data obtained from the decoding apparatus 4 and the random number sequence (R′) obtained from the random number generator 12 to obtain the random number (R). Then, the encoding unit 14b performs error correction encoding to the random number sequence (R) to obtain the codeword (ENC(R)). If the decoding unit 41 has succeeded the error correction, the codeword (ENC(R)) output from the encoding unit 14b is the same as the codeword (ENC (R)) output from the encoding unit 14 in the key initialization phase.

The key generation apparatus 1 according to this embodiment, a random number sequence obtained from the random number generator 12 is superimposed on the decoded data of 710 bits, and the 710-bit superimposed data is divided into 10 data of 71 bits. Then, the encoding unit 14b performs encoding of BCH code to each 10 data of 71 bits.

The codeword ENC (R) is superimposed to the helper data (H). As is clear from the formula (1), the PUF output (I) used in the key initialization phase can be obtained by superimposing the codeword ENC(R) and the helper data (H). The hash value calculating unit 18 can obtain the key (K) by calculating a hash value of PUF output (I) in the same way as the key initialization phase.

As described above, an external apparatus differ from the key generation apparatus includes the decoding unit 41, so a decoding unit is not necessary in the key generation apparatus 1. Therefore a manufacturing cost, calculation amount, and energy consumption can be reduced. In addition, a message between the key generation apparatus 1 and the decoding apparatus 4 is masked by the random number sequence R′ or the encoded random number sequence R′, so the decoding can be left to the external apparatus information-theoretically safely.

Mounting tamper resistant non-volatile memory to store a key in low-end devices is often avoided because of high implementation cost. For example, edge devices of IoT are censers or simple controllers, and these devices are produced a large quantity cheaply. If PUF is used in these low-end devices, key management can be done safely. In addition, the key generation apparatus 1 according to this embodiment, an implementation cost to implement the decoding unit 41 in the key generation apparatus 1 can be reduced, so PUF can be applied to various products and services.

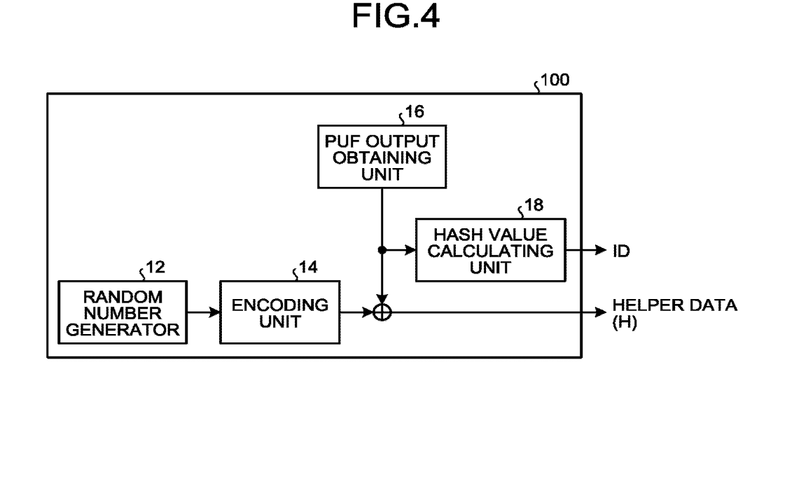

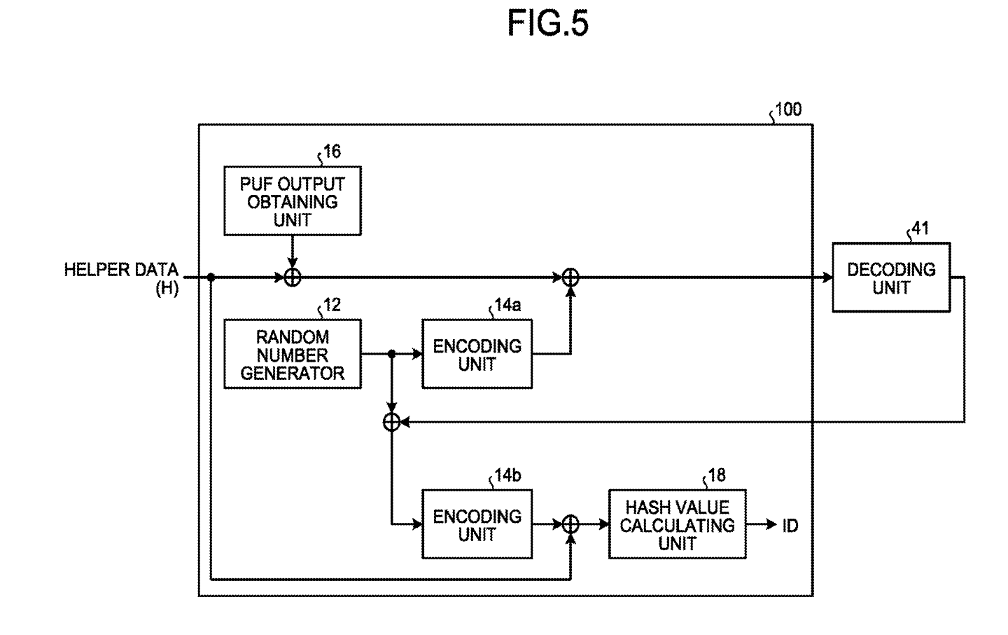

A PUF output can be used in the key generation apparatus as above explained, but it is not limited to the key generation apparatus. For example, when an apparatus generates an ID using a PUF output, above mentioned process can be used. FIG. 4 is a diagram exemplifying a functional configuration of an ID generation apparatus 100 in an ID initialization phase. FIG. 5 is a diagram exemplifying a functional configuration of the ID generation apparatus 100 in an ID regeneration phase. The functional configuration of the ID generation apparatus 100 is same as the key generation apparatus 1.

The random number generator 12, the encoding unit 14/14a/14b, the PUF output obtaining unit 16, the decoding unit 41, and the hash value calculating unit 18 are realized as dedicated processing circuit, for example. Otherwise, the encoding unit 14/14a/14b, the decoding unit 41, and the hash value calculating unit 18 can be realized as software running on a processor.

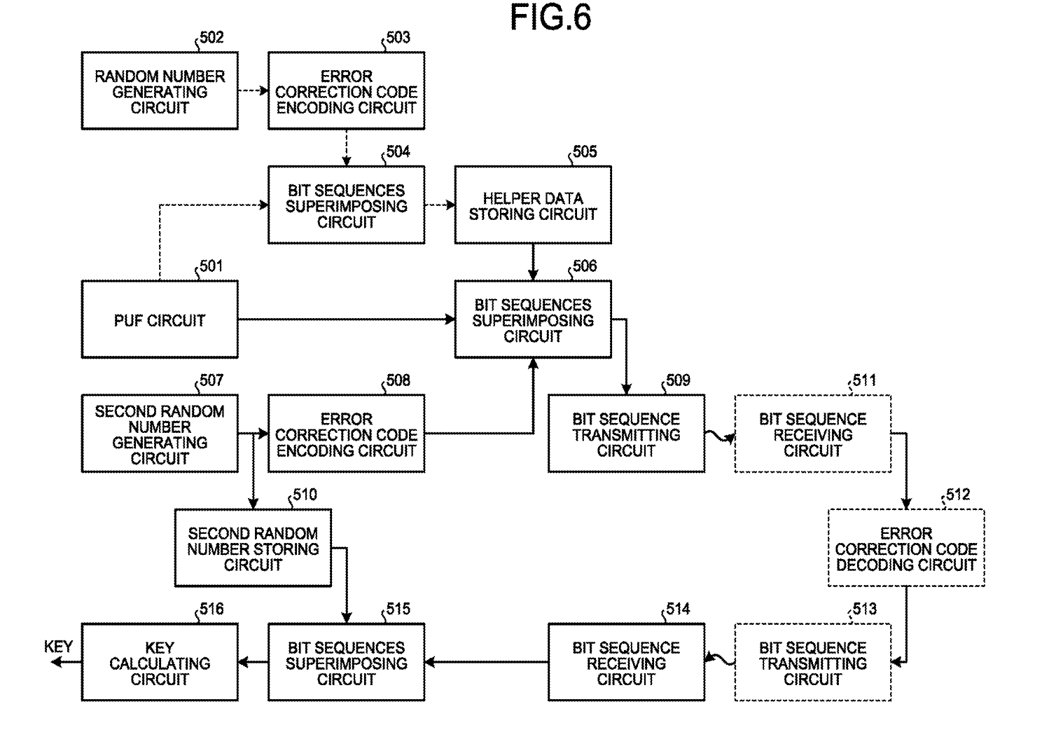

FIG. 6 is a diagram exemplifying hardware configuration of the key generation apparatus 1. In FIG. 6, each functional unit of the key generation apparatus 1 is configured as hardware. In the key initialization phase, a random number generating circuit 502 generates a random number sequence R. An error correction code encoding circuit 503 encodes the random number sequence R to generate a codeword (ENC(R)). The codeword (ENC(R)) is an encoded random number R∥RP. RP represents a parity calculated by encoding the random number sequence R by the error correction codes. The symbol ∥ represents combining bit sequences by concatenation. In a systematic code like a BCH code, codeword (ENC(R)) can be formed by combining an information part (R) and a parity part (RP). A PUF circuit 501 outputs a PUF output value (I). The PUF output value (I) is superimposed on the codeword (ENC(R))=R∥RP output from the error correction code encoding circuit 503 by a bit sequences superimposing circuit 504. A result of the calculation is the helper data (H). The helper data (H) is calculated by formula (1). The helper data is stored in a helper data storing circuit 505.

A process of the key regeneration phase in which key is calculated is explained below. The PUF circuit 501 outputs a PUF output value (I′) again. The PUF output (I′) may be superimposed noise E on the output (I) in the initialization phase. Therefore the PUF output value (I′) can be expressed by the formula (4).

I′=I⊕E (4)

A second random number sequence generating circuit 507 generates a random number sequence R′ which is differ from the random number sequence R. The random number sequence R′ is sent to an error correction code encoding circuit 508 and a second random number sequence storing circuit 510. The error correction code encoding circuit 508 encodes the received random number sequence R′ to calculate a codeword (ENC(R′))=R′∥R′P. R′P represents a parity of R′. The second random number sequence storing circuit stores the random number sequence R′. The second random number sequence generating circuit 507 can use the same circuit as the random number sequence generating circuit 502. A bit sequences superimposing circuit 506 reads the helper data (H) from the helper data storing circuit 505, and superimposes the helper data for every bit on the output (I′) of the PUF circuit 501 and the codeword (ENC(R′))=R′∥R′P output from the error correction code encoding circuit 508. A result of the superimposing is expressed by the formula (2). The result of the superimposing is transferred to a bit sequence transmitting circuit 509. The bit sequence transmitting circuit 509 transmits the result of the superimposing to an external apparatus (decoding apparatus 4). A bit sequence transmitted from the bit sequence transmitting circuit 509 is received by a bit sequence receiving circuit 511 of the external apparatus, and the bit sequence is decoded by an error correction code decoding circuit 512 of the external apparatus. If the noise E is within an error correction capability, the noise E is removed. A result of removing the noise is expressed by:

R⊕R′∥(RP⊕R′P) (5)

A bit sequence transmitting circuit 513 of the decoding apparatus 4 removes the parity part and transmits a bit sequence to the key generation apparatus 1. The bit sequence transmitted from the decoding apparatus 4 is expressed by:

R⊕R′ (6)

A bit sequence receiving circuit 514 receives the bit sequence from the decoding apparatus 4 and transfers it to a bit sequences superimposing circuit 515. The bit sequences superimposing circuit 515 reads the random number R′ from the second random number sequence storing circuit 510 and superimposes on the bit sequence received from the bit sequence receiving circuit 514 for every bit. As a result, the random number sequence (R) can be obtained. A key calculating circuit 516 generates a key from the random number sequence (R) calculated by the bit sequences superimposing circuit 515. If the random number sequence (R) has a property of being random enough for each device, the random number sequence (R) can be used as a key as it is. If the random number sequence (R) is statistically biased, hash value of the random number sequence (R) can be used as a key.

In this embodiment the key generation apparatus 1 executes both of the key initialization phase and the key regeneration phase. However, an apparatus which executes the key initialization phase and an apparatus which executes the key regeneration phase may be different apparatuses.

### (Variations)

In the above explanation, the apparatuses use a PUF output to generate a key or an ID. However, it is not limited to these apparatus. This invention can be applied to an apparatus which calculates any data depending on a PUF output.

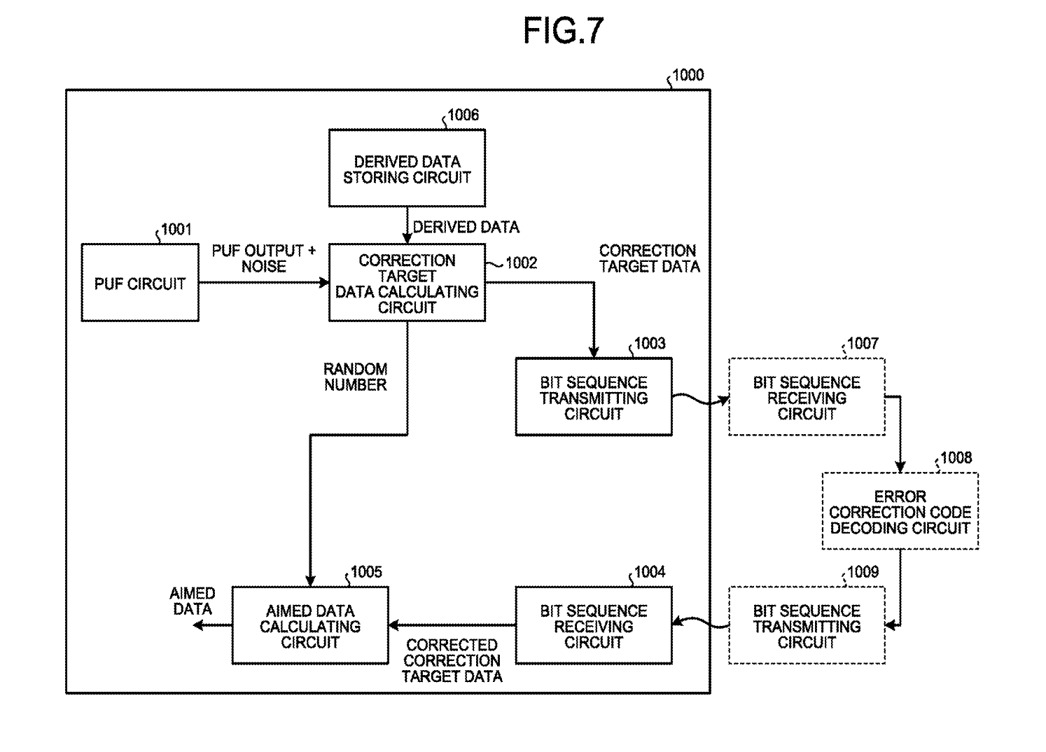

FIG. 7 is a diagram exemplifying hardware configuration of a calculating apparatus 1000. The calculating apparatus 1000 calculates any data depending on a PUF output. A PUF circuit 1001 outputs a PUF output. The PUF output may be superimposed a noise. If an aimed data is calculated by using the PUF output including a noise as it is, the aimed data cannot be calculated correctly. Therefore, a correction target data calculating circuit 1002 calculates a correction target data from a PUF output which may be superimposed a noise, and outputs it to an external apparatus. A random number is used to calculate the correction target data. If the aimed data is data to be concealed such as a key or an ID, it shall be prevented that an attacker presumes the PUF output value. The random number is used not to presume the PUF output value from the correction target data. A bit sequence transmitting circuit 1003 transmits the correction target data to outside the calculating apparatus 1000. The transmitted correction target data is corrected by the external apparatus which is existed outside the calculating apparatus 1000. The external apparatus transmits the corrected correction target data to the calculating apparatus 1000. A bit sequence receiving circuit 1004 receives the corrected correction target data from the external apparatus. An aimed data calculating circuit 1005 receives the corrected correction target data from the bit sequence receiving circuit 1004. The aimed data calculating circuit 1005 also receives the random number which is used to calculate the correction target data from the correction target data calculating circuit 1002. The aimed data calculating circuit 1005 calculates the aimed data from the random number and the corrected correction target data.

A detailed configuration of the correction target data calculating circuit 1002 and the aimed data calculating circuit 1005 is described below. The correction target data calculating circuit 1002 combines the PUF output and a parity P=(p1, p2, . . . , p(n−k)). The PUF output which is output from the PUF circuit 1001 is expressed by:

I⊕E=(i1⊕e1,i2⊕e2, . . . ,ik⊕ek) (7)

The combined data is expressed by:

(I⊕E)∥P=(i1⊕e1,i2⊕e2, . . . ,ik⊕ek,p1,p2, . . . p(n−k)) (8)

I=(i1, i2, . . . , ik) represents a PUF output which does not include a noise. Here, noises are differences between the PUF output of the initialization phase and those of the regeneration phase. E=(e1, e2, . . . , ek) represents a bit sequence expresses a noise. The length of the PUF output is k bits, the whole length of the combined data is n bits, and the length of the parity is (n-k) bits. The symbol ∥ represents a combination of bit sequences. The symbol of XOR represents a bitwise superimposing of bit sequences by XOR, or it represents XOR of bit. The parity P is a parity which is generated by performing error correction encoding to a PUF output which is not include a noise. The parity may be hardwired in a circuit, or it may be stored in a derived data storing circuit 1006. Next, the correction target data calculating circuit 1002 generates a random number R=(r1, r2, . . . , rk), performs the error correction encoding to the random number R, and generates a parity RP=(rp1, . . . , rp(n−k)). The correction target data calculating circuit 1002 combines the random number R and the parity RP of the random number R, and superimposes the combined data R∥RP on the combined data expressed by the formula (8) for every bit. The data obtained by this process is the correction target data, and it is expressed by:

((I⊕E)∥P)(R∥RP) (9)

The correction target data transmits to outside of the apparatus as a transmitting bit sequence by the bit sequence transmitting circuit. The external apparatus includes a bit sequence receiving circuit 1007, an error correction code decoding circuit 1008, and a bit sequence transmitting circuit 1009. These circuits have the same configuration as the bit sequence receiving circuit 511, the error correction code decoding circuit 512, and the bit sequence transmitting circuit 513 explained by using FIG. 6. The transmitting bit sequence is corrected by the error correction code decoding circuit 1008 of the external apparatus. If the noise E included in the PUF output is within an error correction capability, the noise E can be removed by the decoding. In this case, the corrected data is expressed by:

(I∥P)⊕(R∥RP) (10)

Data obtained by removing the parity part from the corrected data is expressed by:

I⊕R (11)

The data is returned to the calculating apparatus 1000 as a receiving bit sequence. The receiving bit sequence expressed by formula (11) is the corrected correction target data received by the bit sequence receiving circuit 1004 and transmitted to the aimed data calculating circuit 1005.

The aimed data calculating circuit 1005 superimposes the corrected correction target data received from the bit sequence receiving circuit 1004 on the random number R received from the correction target data calculating circuit 1002 for every bit to obtain the aimed data. The aimed data is expressed by:

(I⊕R)⊕R=I (12)

The aimed data coincides with the PUF output which is not includes a noise. The PUF output is expected to have randomness, so as to the PUF outputs are different for every device. If the randomness doesn't have enough entropy, the calculating apparatus 1000 may further includes a hash value calculating circuit. The has value calculating circuit calculates a hash value of the PUF output I which is calculated by the aimed data calculating circuit 1005, and the hash value is treated as the aimed data. In more general, a result of any function calculated with the aimed data as an input can also be the aimed data calculated by the aimed data calculating circuit.

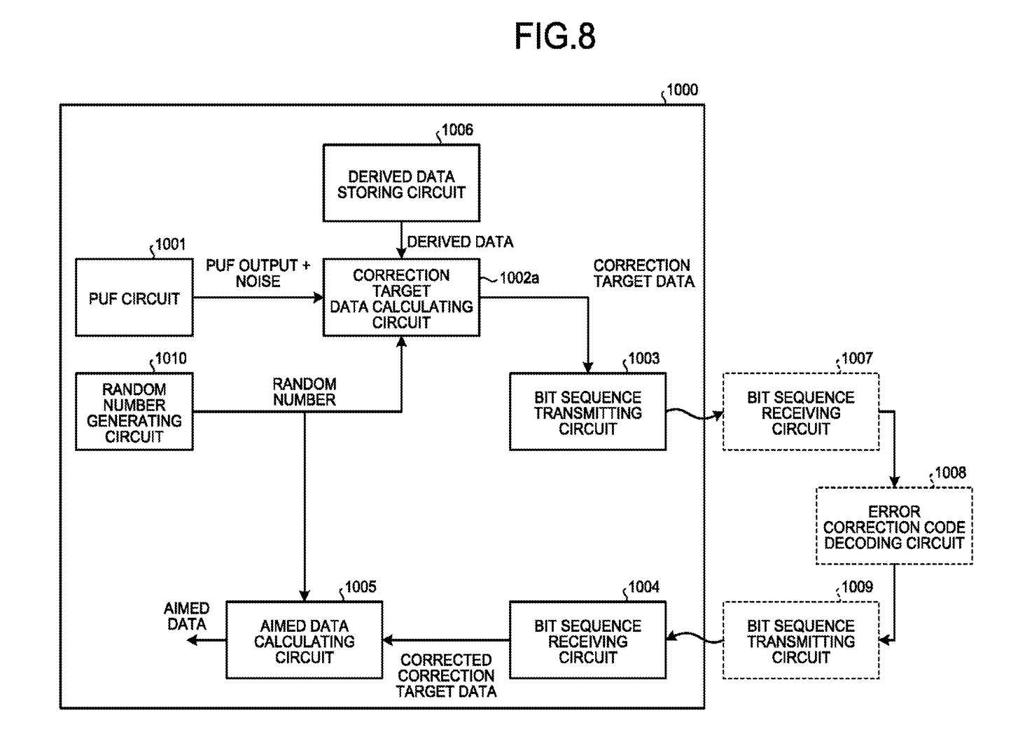

In the calculating apparatus 1000 shown in the FIG. 7, the correction target data calculating circuit 1002 generates the random number R and transmits the random number R to the aimed data calculating circuit 1005. However, the configuration can be changed. In FIG. 8, the calculating apparatus 1000 further includes an independent random number generating circuit 1010 generates the random number R and transmits the generated random number R to the correction target data calculating circuit 1002a and the aimed data calculating circuit 1005.

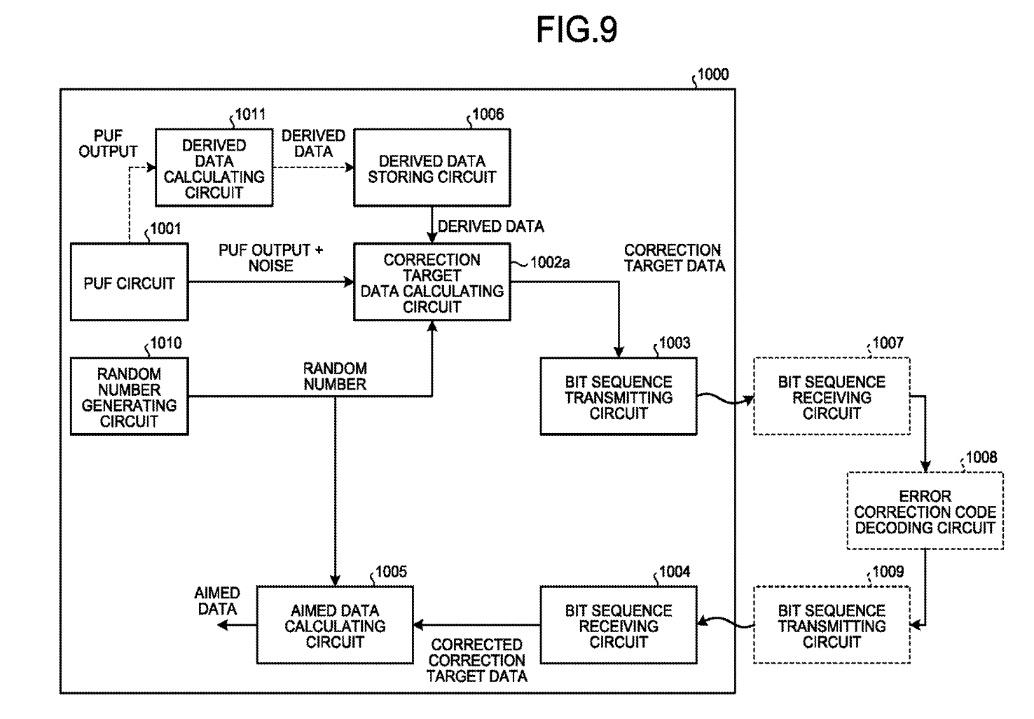

In addition, the calculating apparatus 1000 shown in the FIG. 7 stores the parity P of the PUF output I in the derived data storing circuit 1006 or the parity P is hardwired. It requires high cost to implement a different circuit for each device or to store different data for each device because the PUF output value I is different for each device. The calculating apparatus 1000 shown in FIG. 9 further includes a derived data calculating circuit 1011. The derived data calculating circuit 1011 calculates the parity and the derived data storing circuit 1006 stores the parity. According to the calculating apparatus 1000 shown in FIG. 9, it is not necessary to implement different circuit for each device. A value of the parity stored in the derived data storing circuit 1006 is different for each device, but the calculation of the parity is done in the same circuit in every device.

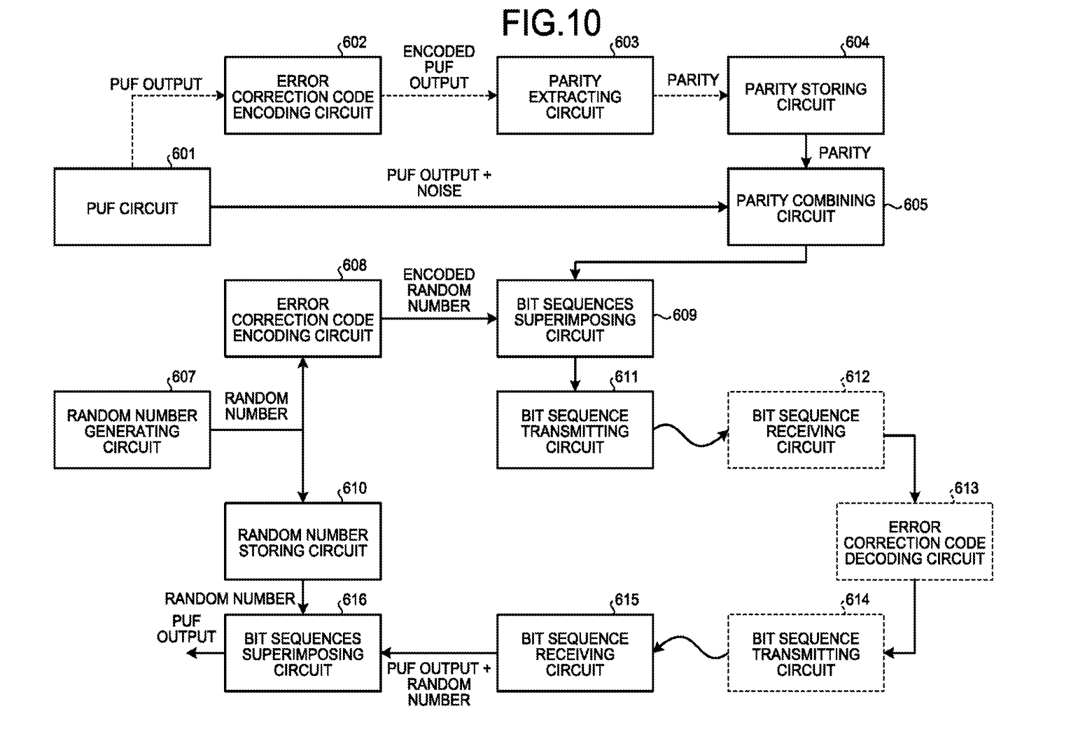

FIG. 10 is a diagram showing details of the derived data calculation. At first, an initialization phase will be explained. A PUF circuit 601 outputs a PUF output I. A error correction code encoding circuit 602 encodes the PUF output, and outputs the encoded PUF output I∥P. P represents a parity calculated in the encoding circuit. A parity extracting circuit 603 extracts the parity P from the encoded PUF output I∥P. A parity storing circuit 604 stores the parity P. Next, a aimed data calculating phase in which PUF output is calculated as an example of the aimed data will be explained. The PUF circuit 601 outputs a PUF output on which may be superimposed a noise. The PUF output on which may be superimposed a noise can be expressed by the formula (7). A parity combining circuit 605 reads the parity P stored in the parity storing circuit 604, and combines the parity P and the PUF output. The combined data by the parity combining circuit 605 can be expressed by the formula (8).

A random number generating circuit 607 generates a random number R. The generated random number R is sent to an error correction code encoding circuit 608 and a random number storing circuit 610. The error correction code encoding circuit 608 and the error correction code encoding circuit 602 can be use the same circuit. The error correction code encoding circuit 608 encodes the random number R and obtains R∥RP. RP represents a parity of the random number R. A bit sequences superimposing circuit 609 calculates the correction target data expressed by the formula (9) by superimposing the data expressed by the formula (8) calculated by the parity combining circuit 605 and R∥RP calculated by the error correction code encoding circuit 608. A bit sequence transmitting circuit 611 transmits the calculated correction target data as a transmitting bit sequence. The transmitting bit sequence is received by the bit sequence receiving circuit 612 in an external apparatus which exists outside the calculating apparatus 1000. An error correction code decoding circuit 613 in the external apparatus performs an error correction code decoding on the transmitting bit sequence. If a noise superimposed on the PUF output is within an error correction capability, the noise can be removed. A bit sequence transmitting circuit 614 in the external apparatus returns the bit sequence on which error is removed. The returned bit sequence is expressed by the formula (11). A bit sequence receiving circuit 615 transfers the received bit sequence to a bit sequences superimposing circuit 616. The bit sequences superimposing circuit 616 superimposes the received bit sequence received from the bit sequence receiving circuit 615 and the random number R received from the random number storing circuit 610 for every bit. The bit sequences superimposing circuit 616 and the bit sequences superimposing circuit 609 can be the same circuit.

While certain embodiments have been described, these embodiments have been presented by way of example only, and are not intended to limit the scope of the inventions.

Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a processor obtaining a first PUF output;
a transmitter transmitting a transmitting data based on the first PUF output to an external apparatus; and
a receiver receiving an error corrected data from the external apparatus, the error corrected data being obtained by an error correction to the first PUF output,
wherein the processor is further configured to calculate information based on the error corrected data.

2. The apparatus according to claim 1, wherein
the processor is further configured to obtain a first random number and encode the first random number by an error correction code to obtain a code, and
the transmitting data is calculated using the first PUF output and the code.

3. The apparatus according to claim 2, wherein
the error correction code used to encode the first random number is a linear code.

4. The apparatus according to claim 2, wherein
the transmitting data is calculated by superimposing the first PUF output and the code on helper data, the helper data is calculated by superimposing data obtained by encode a second random number encoded by the error correction code on a second PUF output.

5. The apparatus according to claim 2, wherein
the information is calculated based on a result of superimposing the error corrected data on the first random number.

6. An information processing apparatus comprising:
a PUF circuit outputting a PUF output;
an error correction target data calculation circuit obtaining the PUF output and calculating an error correction target data based on the PUF output and a random number;
a transmitting circuit transmitting the error correction target data to an external apparatus;
a receiving circuit receiving a decoded error correction target data; and
an aimed data calculating circuit calculating data based on the decoded error correction target data and the random number.
